(19) United States
(12) Patent Application Publication
(10) Pub. No.: US 2007/0059415 A1
(43) Pub. Date: Mar. 15, 2007

(54) CO2 CONTAINING ANTIMICROBIAL FORMULATIONS TO TREAT FOOD PRODUCTS DURING PROCESSING STEPS

(76) Inventors: Meenakshi Sundaram, Burr Ridge, IL (US); Pasi Ihatsu, Kontiolahti as. (FI)

Correspondence Address: Ms. Linda K. Russell, Air Liquide Intellectual Property Dept., 2700 Post Oak Blvd., Suite 1800, Houston, TX, 77056, US

(21) Appl. No.: 11/457,587

(22) Filed: Jul. 14, 2006

Related U.S. Application Data
(60) Provisional application No. 60/716,689, filed on Sep. 13, 2005.

(51) Int. Cl. A23L 3/3463

(52) U.S. Cl. 426/335

(57) ABSTRACT

Embodiments of the invention generally provide antimicrobial formulations incorporating a carrier chemical in carbon dioxide (CO₂) to treat food products during processing steps.

### CROSS-REFERENCE TO RELATED APPLICATIONS

This application claims the benefit under 35 U.S.C. §119(e) to provisional application No. 60/716,689, filed Sep. 13, 2005, the entire contents of which are incorporated herein by reference.

### BACKGROUND

1. Field of the Invention

The invention relates to the improvement of sanitization techniques used during the processing of food products, more specifically to an antimicrobial formulation incorporating a carrier chemical in carbon dioxide (CO₂) to treat food products during processing steps.

2. Description of the Related Art

Food safety problems not only originate in the food product itself (e.g., raw ingredients), but also from the environment surrounding the food product. A food product is susceptible to microbial contamination during the processing steps and after the terminal heating process. Operations with poor sanitation in the packing environment can significantly increase the risk of contaminating a food product. For example, pathogenic microorganisms may be found on the floors and in the drains in the packing facility and on the surfaces of sorting, grading, and packing equipment. Without good sanitary practices, any of these surfaces that come in contact a food product could be a potential source of microbial contamination.

According to at least one estimate, post/cross contamination from either environment or food contact surfaces is implicated in up to 30% of food poisoning cases. Post/cross contamination also increases the microbial load in finished products, shortening shelf-life and becoming a visual deterrent of quality. As such, the finished product can serve as a carrier of cross-contamination leading to economic losses, as well as health and survival issues involving consumers. For example, Listeria spp is an environmental air-borne pathogen causing listeriosis that can contaminate food products during processing. According to the Center for Disease Control, there were 1850 cases of listeriosis in 1998, including 435 deaths from this disease. Effective methods using sanitizers/disinfectants are crucial to minimize and prevent microbial contamination of foods.

Effective sanitation of food or other items depends on the combination of what is to be sanitized and the sanitation process type. Not all of the currently available technologies can deliver an effective reduction of microorganisms and at the same time prevent product or environmental degradation. It is well known in the art to cool products, such as foods, during processing with some type of refrigerant to slow down the growth of unwanted microbes and enzymatic reactions in foods. For instance, the shelf life and quality of food products are improved by processing, transporting, and storing under refrigerated conditions.

Cooling agents, such as dry ice, are solid agents that can be used as expendable refrigerants. Water ice is a traditional expendable refrigerant, but has the disadvantage of converting to water after the ice melts. Solid CO₂, or dry ice, sublimes by going directly from a solid to a gas without passing through the liquid stage. The cold temperature of dry ice and the fact that it leaves no residue like water ice makes it an excellent refrigerant in some applications. For example, when transporting food products that must remain frozen, the food can be packed with dry ice. However, since dry ice is a solid, it cannot readily be injected into equipment typically used in the processing of food products.

Liquids are also utilized to cool and inert the atmosphere during food processing or storage. There are many applications that use liquid CO₂ as the coolant to chill and freeze food products (beef, poultry, seafood, etc.) during processing steps. Liquid CO₂ can be injected into various types of equipment involved in food processing such as tumblers, mixers, and blenders to effectively refrigerate the equipment for extended periods of time.

Although refrigeration can retard microbial growth, such treatment does not necessarily kill bacteria. Accordingly, microorganisms can still survive through refrigeration, and worse, some microorganisms can still grow and produce harmful substances during refrigerated storage. It is desirable to sanitize equipment and processed foods with a combination of cooling properties found in cooling agents and antimicrobial capabilities of sanitizing agents. It is further desirable to expose the equipment or food product to a cooling agent and sanitizing agent simultaneously.

Therefore, there remains a need to provide antimicrobial properties to cooling agents.

### SUMMARY

Embodiments of the invention generally provide an antimicrobial formulation incorporating a carrier chemical in carbon dioxide to treat food products and equipment during processing steps. In one embodiment, the invention provides a method of treating a target item comprising exposing the target item to a treating agent, wherein the treating agent comprises carbon dioxide and a carrier chemical having antimicrobial agents mixed with the carbon dioxide, wherein the antimicrobial agents are in a liquid or solid form.

In another embodiment, the invention provides an antimicrobial formulation comprising carbon dioxide, and a carrier chemical having antimicrobial properties mixed with the carbon dioxide.

In another embodiment, the invention provides an antimicrobial formulation comprising carbon dioxide, a carrier chemical mixed with the carbon dioxide, and one or more antimicrobial ingredients soluble in the carrier chemical mixed with the mixture of the carrier chemical and the carbon dioxide to form a substance having antimicrobial properties.

In another embodiment, the invention provides an antimicrobial formulation comprising carbon dioxide, water mixed with the carbon dioxide, and one or more antimicrobial ingredients soluble in water mixed with the mixture of the water and the carbon dioxide to form a substance having antimicrobial properties.

In another embodiment, the invention provides an antimicrobial formulation comprising carbon dioxide, water mixed with the carbon dioxide, a carrier chemical mixed with the mixture of the water and the carbon dioxide, and one or more antimicrobial ingredients soluble in water mixed with the mixture of the carrier chemical, the water and the carbon dioxide to form a substance having antimicrobial properties.

In another embodiment, the invention provides an antimicrobial formulation comprising carbon dioxide, water mixed with the carbon dioxide, a carrier chemical mixed with the mixture of the water and the carbon dioxide, one or more antimicrobial ingredients soluble in water mixed with the mixture of the carrier chemical, the water and the carbon dioxide, and one or more antimicrobial ingredients soluble in the carrier chemical mixed with the mixture of the carrier chemical, the water, the carbon dioxide, and the one or more antimicrobial ingredients to form a substance having antimicrobial properties.

In another embodiment, the invention provides an antimicrobial formulation comprising carbon dioxide, a carrier chemical mixed with the carbon dioxide, and one or more additives that are not antimicrobials mixed with the mixture of the carrier chemical and the carbon dioxide to form a substance having antimicrobial properties.

In another embodiment, the invention provides an antimicrobial formulation comprising carbon dioxide, a carrier chemical mixed with the carbon dioxide, one or more antimicrobial ingredients soluble in the carrier chemical mixed with the mixture of the carrier chemical and the carbon dioxide, and one or more additives that are not antimicrobials mixed with the mixture of the one or more antimicrobial ingredients soluble in the carrier chemical, the carrier chemical, and the carbon dioxide to form a substance with antimicrobial properties.

In another embodiment, the invention provides an antimicrobial formulation comprising carbon dioxide, water mixed with the carbon dioxide, one or more antimicrobial ingredients soluble in water mixed with the mixture of the water and the carbon dioxide, and one or more additives that are not antimicrobials mixed with the mixture of the one or more antimicrobial ingredients soluble in water, the water, and the carbon dioxide to form a substance with antimicrobial properties.

In another embodiment, the invention provides An antimicrobial formulation comprising carbon dioxide, water mixed with the carbon dioxide, a carrier chemical mixed with the mixture of the water and the carbon dioxide, one or more antimicrobial ingredients soluble in water mixed with the mixture of the carrier chemical, the water, and the carbon dioxide, one or more antimicrobial ingredients soluble in the carrier chemical mixed with the mixture of the one or more antimicrobial ingredients soluble in water, the carrier chemical, the water, and the carbon dioxide, and one or more additives that are not antimicrobials mixed with the mixture of the one or more antimicrobial ingredients soluble in the carrier chemical, the one or more antimicrobial ingredients soluble in water, the carrier chemical, the water, and the carbon dioxide to form a substance with antimicrobial properties.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a flow diagram of a process 100 used to create an antimicrobial formulation according to one embodiment of the present invention; and

FIG. 2 illustrates an apparatus 200 used to create an antimicrobial formulation and treat a food product according to an embodiment described by process 100.

### DESCRIPTION OF PREFERRED EMBODIMENTS

The words and phrases used herein should be given their ordinary and customary meaning in the art by one skilled in the art unless otherwise further defined.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

A food product is susceptible to microbial contamination during virtually all steps of preparation. While refrigeration can retard microbial growth, such treatment does not necessarily kill bacteria. Accordingly, microorganisms can still survive through refrigeration, and worse, some microorganisms can still grow and produce harmful substances during refrigerated storage. It is desirable to sanitize equipment or devices and process foods using a combination of the cooling properties of cooling agents with the antimicrobial capability of sanitizing agents. Embodiments of the invention generally provide an antimicrobial formulation incorporating a carrier chemical in CO₂ to treat food products (e.g., meat and poultry products) during processing steps. Particular embodiments are described with respect to liquid CO₂, however, more generally, liquid or gaseous CO₂ may be used to advantage.

As used in this invention, the term “antimicrobial” refers to a physical or chemical agent capable of causing greater than 90% reduction (1-log order reduction) in the population of bacteria or spores within 10 seconds at 60° C. The antimicrobial formulation used in embodiments the invention preferably provides greater than a 99% reduction (2-log order reduction), and more preferably greater than a 99.99% (4-log order reduction), and most preferably a 99.999% (5-log order reduction) in such a population preferably within 60 seconds at 60° C., and preferably within 10 seconds at 60° C.

Antimicrobial agents are used to sanitize equipment, provide aseptic environments, and sanitize foods while reducing spoilage of the food product. The reaction of antimicrobial agents with microbial cell structures is often irreversible; therefore, the cells either become attenuated or die. Embodiments of this invention provide antimicrobial agents to CO₂. The formulation can be premixed before, during, or after a liquid CO₂ injection step into any desired equipment used prior to food processing, or during processing. Examples of equipment into which the antimicrobial formulation can be injected include mixers, blenders, and tumblers.

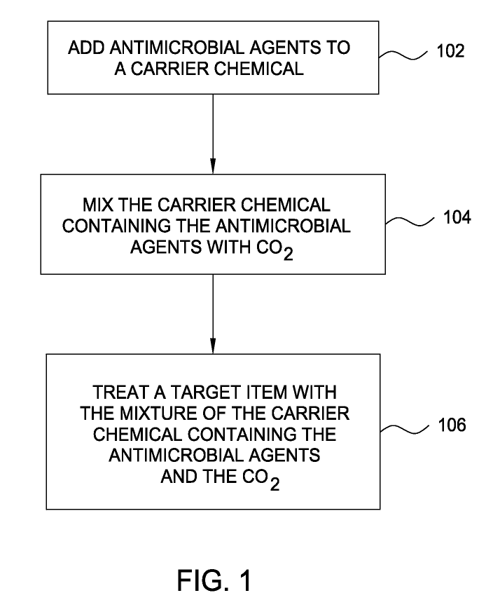

FIG. 1 is a flow diagram of a process 100 used to create an antimicrobial formulation according to one embodiment of the present invention. The process 100 includes a processing step 102 involving adding various antimicrobial agents to a carrier chemical. The next processing step 104 involves mixing the carrier chemical containing the antimicrobial agents with CO₂. Finally, processing step 106 involves treating a target item with the mixture of the carrier chemical containing the antimicrobial agents and the CO₂.

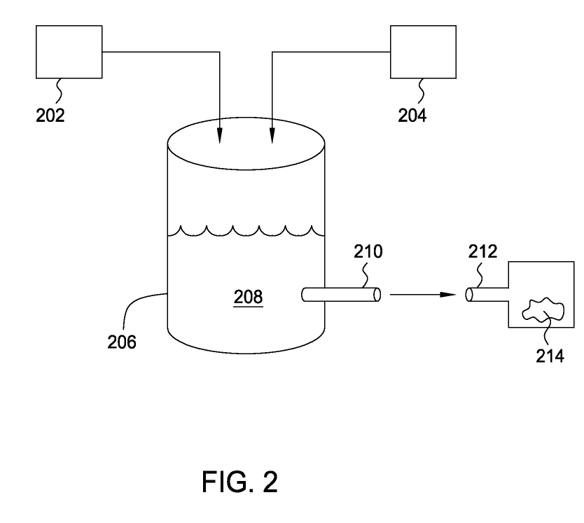

FIG. 2 illustrates an apparatus 200 used to create an antimicrobial formulation and treat a food product according to an embodiment described by process 100. A source 202 provides a carrier chemical with antimicrobial agents to a mixing vessel 206. A source 204 provides liquid CO₂ to the mixing vessel 206, creating a mixture 208 of the carrier chemical with antimicrobial agents and the carbon dioxide. A conduit 210 allows the mixture 208 to leave the vessel and eventually flow to a container 212. The mixture 208 of the carrier chemical with antimicrobial agents and the carbon dioxide is injected into the container 212 to treat a food product 214 in the container.

Liquid CO₂ is usually maintained at a temperature of about −60° C. at a pressure of 5.11 atm. In embodiments of the invention, the antimicrobial agents used may have freezing points higher, lower, or similar to that of liquid CO₂. Embodiments of the invention can involve mixing one or more antimicrobial agents with the carrier chemical to a final concentration without affecting the freezing point of the carrier chemical. In a preferred embodiment, a combined solution prepared using a carrier chemical and one or more antimicrobial agents should not have a freezing point higher than that of liquid CO₂. In other embodiments of the invention, it may be desirable to tune the freezing point of a mixture containing a carrier chemical and one or more antimicrobial agents. In one potential application of the invention, liquid CO₂ combined with a carrier chemical/antimicrobial mixture is fed to an ice press to form dry ice. Yet another application of the invention involves feeding liquid CO₂ and a carrier chemical/antimicrobial mixture to an ice press as separate streams, which then combine in the press to generate dry ice “snow” containing antimicrobial properties. In one embodiment, the antimicrobial agents in the antimicrobial formulation are listed by the U.S. Food and Drug Administration as being GRAS (Generally Recognized as Safe).

The antimicrobial formulation can contain an alcohol, a terpene, or polyethylene glycol as a carrier chemical in various embodiments. An alcohol is any organic compound in which a hydroxyl group (—OH) is bound to a carbon atom of an alkyl or substituted alkyl group. The general formula for a simple acyclic alcohol is CₙH₂ₙ₊₁OH. Food grade alcohol, ethanol, is a carrier chemical that has a very low freezing point, and can be used in one embodiment of the invention. Terpenes are another large group of chemicals compounds found in nature that act as effective carrier chemicals with low freezing points. One such example is D-limonene, present in orange peel and extracted from the orange skin. The freezing point of D-Limonene is suitable for liquid CO₂ storage conditions. In general, ethanol and D-Limonene can be considered to be effective carrier chemicals used in formulation preparation with desired antimicrobial ingredients. Polyethylene glycol is a non-toxic liquid with low molecular weight, and is a common ingredient of antimicrobial pharmaceuticals.

Various food additives listed as GRAS can be dissolved directly into the carrier chemical and then mixed with liquid CO₂. Other embodiments of the invention can involve mixing one or more food additives with water, ethanol, or other solvent, and then adding the solution to the carrier chemical to a final concentration without affecting the freezing point of the carrier chemical.

One embodiment of the invention involves the addition of the food additive MIRENAT-N, manufactured by Vedeqsa Lamirsa Group based in Barcelona, Spain and distributed in the U.S. by A & B Ingredients (Fairfield, N.J.). MIRENAT-N is manufactured from a naturally occurring antimicrobial compound, and its active ingredient is lauric arginate (N-lauroyl-L-Arginine ethyl ester monohydrochloride). The formulation available for sale contains about 10% active lauric arginate and 90% food grade propylene glycol. It is possible to substitute ethanol for propylene glycol as the carrier chemical when using MIRENAT-N. Advantages of using MIRENAT-N may include: minimal modification of original product, low application use dosage, and well known antimicrobial activity. Based on the manufacturer's specifications, MIRENAT-N can be manufactured to be lower than 11% active in ethanol. MIRENAT, either in propylene glycol, or ethanol, when treated with meat or poultry, can lose its efficacy over time, due to enzymatic reactions. Such problems can be overcome by adding other preservatives or antimicrobials to MIRENAT-N.

Other antimicrobial additives used in embodiments of the invention could include natural lactic acid, lactates, gluconates, and lacititol. The solubility of the following products manufactured by Purac (Lincolnshire, Ill.) was tested: potassium gluconate, ammonium lactate, potassium lactate, sodium lactate, sodium lactate powder, and sodium diacetate. Based on solubility testing, all liquid forms of these additives were found to be ethanol soluble. Other antimicrobial additives could include parabens, a group of chemicals which are derivatives of phenol. Parabens are widely used as preservatives in the cosmetic and pharmaceutical industries, and are also popular in the meat processing industry. Methyl paraben, sold by The KIC Group (Vancouver, Wash.), is also soluble in ethanol and not soluble in water. Thus, methyl paraben can be a preservative or antimicrobial added in one embodiment of the formulation with ethanol as the carrier chemical.

Other antimicrobials that are not directly soluble in ethanol but soluble in water can be also be used in embodiments of the invention. Examples include would potassium nitrite and potassium nitrate. These salts can be dissolved in water and further mixed with ethanol. The final formulation of ethanol can be adjusted such that it does not freeze under liquid CO₂ storage conditions. The ethanol formulation could be adjusted by starting with an amount of high purity ethanol and diluting the ethanol with water containing antimicrobials, such that a final formulation is still compatible with liquid CO₂ temperatures.

In general, salts of organic acids (propinates, sorbates, benzoates and lactate) are preservatives that act by increasing the proton concentration of the cytoplasm of many microbes. Under mild conditions, they are protonated, since they are weak acids. The relative non-polarity of these salts allows the salts to penetrate the cellular membrane of bacteria and other microorganisms. Once inside the cell, these acids dissociate (releasing protons), due to the lower proton concentration of cytoplasm. Microorganisms, to maintain their proton concentration, they must compensate for these acids by discharging protons using ATP synthesis. This in turn disrupts ATP synthesis, and causes the microbes to die. Hence, the addition of these salts can enhance the antimicrobial efficacy of the formulation proposed in the invention.

Other GRAS chemicals listed as food additives, but are not antimicrobials, can also be introduced in the formulation to bring additional benefits other than antimicrobial effects. These additives include flavoring agents, flavor enhancers, intensifiers, emulsifiers, binders, fillers, gelling agents, plasticizers, stabilizers, suspending agents, whipping agents, sweetening agents, flavoring agents, colors, enzymes, antioxidants, sequestrants, wetting agents, surfactants, curing and pickling agents, firming agents, fumigants, humectants, leavening agents, processing aids, surface active agents, surface finishing agents, synergists, and texturizers.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method of treating a target item comprising exposing the target item to a treating agent, wherein the treating agent comprises carbon dioxide and a carrier chemical having antimicrobial agents mixed with the carbon dioxide, and wherein the antimicrobial agents are in a liquid or solid form.

2. The method of claim 1, wherein the target item is a food product.

3. The method of claim 1, wherein the target item is selected from the group consisting of a tunnel, a tumbler, a blender, a plate, a chamber, a vessel, packages, transportation containers, and combinations thereof.

4. The method of claim 1, wherein the carbon dioxide is in liquid form.

5. The method of claim 1, wherein the carrier chemical is an alcohol.

6. The method of claim 5, wherein the alcohol is ethanol.

7. The method of claim 1, wherein the carrier chemical is propylene glycol.

8. The method of claim 1, wherein the carrier chemical is a terpene.

9. The method of claim 8, wherein the terpene is D-limonene.

10. The method of claim 1, wherein the carrier chemical contains one or more antimicrobial ingredients soluble in the carrier chemical.

11. The method of claim 10, wherein the one or more antimicrobial ingredients soluble in the carrier chemical is selected from the group consisting of lauric argenate, potassium gluconate, ammonium lactate, potassium lactate, sodium lactate, sodium diacetate, methyl paraben and combinations thereof.

12. The method of claim 1, wherein the carrier chemical contains one or more antimicrobial ingredients soluble in water.

13. The method of claim 12, wherein the one or more antimicrobial ingredients soluble in water is selected from the group consisting of potassium nitrite, potassium nitrate, and combinations thereof.

14. The method of claim 1, wherein the carrier chemical contains one or more additives that are not antimicrobials.

15. The method of claim 14, wherein the one or more additives that are not antimicrobials is selected from the group consisting of flavoring agents, flavor enhancers, intensifiers, emulsifiers, binders, fillers, gelling agents, plasticizers, stabilizers, suspending agents, whipping agents, sweetening agents, flavoring agents, colors, enzymes, antioxidants, sequestrants, wetting agents, surfactants, curing and pickling agents, firming agents, fumigants, humectants, leavening agents, processing aids, surface active agents, surface finishing agents, synergists, texturizers, and combinations thereof.

16. An antimicrobial formulation comprising:
a) carbon dioxide; and
b) a carrier chemical having antimicrobial properties mixed with the carbon dioxide.

17. The formulation according to claim 16, wherein the carbon dioxide is in liquid form.

18. The formulation according to claim 16, wherein the carrier chemical is an alcohol.

19. The formulation according to claim 18, wherein the alcohol is ethanol.

20. The formulation according to claim 16, wherein the carrier chemical is propylene glycol.

21. The formulation according to claim 16, wherein the carrier chemical is a terpene.

22. The formulation according to claim 21, wherein the terpene is D-limonene.

23. An antimicrobial formulation comprising:
a) carbon dioxide;
b) a carrier chemical mixed with the carbon dioxide; and
c) one or more antimicrobial ingredients soluble in the carrier chemical mixed with the mixture of the carrier chemical and the carbon dioxide to form a substance having antimicrobial properties.

24. The formulation according to claim 23, wherein the carbon dioxide is in liquid form.

25. The formulation according to claim 23, wherein the carrier chemical is an alcohol.

26. The formulation according to claim 25, wherein the alcohol is ethanol.

27. The formulation according to claim 23, wherein the carrier chemical is propylene glycol.

28. The formulation according to claim 23, wherein the carrier chemical is a terpene.

29. The formulation according to claim 28, wherein the terpene is D-limonene.

30. The formulation according to claim 23, wherein the one or more antimicrobial ingredients soluble in the carrier chemical is selected from the group consisting of lauric argenate, potassium gluconate, ammonium lactate, potassium lactate, sodium lactate, sodium diacetate, methyl paraben and combinations thereof.

31. An antimicrobial formulation comprising:
a) carbon dioxide;
b) water mixed with the carbon dioxide; and
c) one or more antimicrobial ingredients soluble in water mixed with the mixture of the water and the carbon dioxide to form a substance having antimicrobial properties.

32. The formulation according to claim 31, wherein the carbon dioxide is in liquid form.

33. The formulation according to claim 31, wherein the one or more antimicrobial ingredients soluble in water is selected from the group consisting of potassium nitrite, potassium nitrate, and combinations thereof.

34. An antimicrobial formulation comprising:
a) carbon dioxide;
b) water mixed with the carbon dioxide;
c) a carrier chemical mixed with the mixture of the water and the carbon dioxide: and
d) one or more antimicrobial ingredients soluble in water mixed with the mixture of the carrier chemical, the water and the carbon dioxide to form a substance having antimicrobial properties.

35. The formulation according to claim 34, wherein the carbon dioxide is in liquid form.

36. The formulation according to claim 34, wherein the carrier chemical is an alcohol.

37. The formulation according to claim 36, wherein the alcohol is ethanol.

38. The formulation according to claim 34, wherein the carrier chemical is propylene glycol.

39. The formulation according to claim 34, wherein the carrier chemical is a terpene.

40. The formulation according to claim 39, wherein the terpene is D-limonene.

41. The formulation according to claim 34, wherein the one or more antimicrobial ingredients soluble in water is selected from the group consisting of potassium nitrite, potassium nitrate, and combinations thereof.

42. An antimicrobial formulation comprising:
a) carbon dioxide;
b) water mixed with the carbon dioxide;
c) a carrier chemical mixed with the mixture of the water and the carbon dioxide;
d) one or more antimicrobial ingredients soluble in water mixed with the mixture of the carrier chemical, the water and the carbon dioxide; and
e) one or more antimicrobial ingredients soluble in the carrier chemical mixed with the mixture of the carrier chemical, the water, the carbon dioxide, and the one or more antimicrobial ingredients to form a substance having antimicrobial properties.

43. The formulation according to claim 42, wherein the carbon dioxide is in liquid form.

44. The formulation according to claim 42, wherein the carrier chemical is an alcohol.

45. The formulation according to claim 44, wherein the alcohol is ethanol.

46. The formulation according to claim 42, wherein the carrier chemical is propylene glycol.

47. The formulation according to claim 42, wherein the carrier chemical is a terpene.

48. The formulation according to claim 47, wherein the terpene is D-limonene.

49. The formulation according to claim 42, wherein the one or more antimicrobial ingredients soluble in water is selected from the group consisting of potassium nitrite, potassium nitrate, and combinations thereof.

50. The formulation according to claim 42, wherein the one or more antimicrobial ingredients soluble in the carrier chemical is selected from the group consisting of lauric argenate, potassium gluconate, ammonium lactate, potassium lactate, sodium lactate, sodium diacetate, methyl paraben and combinations thereof.

51. An antimicrobial formulation comprising:
a) carbon dioxide;
b) a carrier chemical mixed with the carbon dioxide; and
c) one or more additives that are not antimicrobials mixed with the mixture of the carrier chemical and the carbon dioxide to form a substance having antimicrobial properties.

52. The formulation according to claim 51, wherein the carbon dioxide is in liquid form.

53. The formulation according to claim 51, wherein the carrier chemical is an alcohol.

54. The formulation according to claim 53, wherein the alcohol is ethanol.

55. The formulation according to claim 51, wherein the carrier chemical is propylene glycol.

56. The formulation according to claim 51, wherein the carrier chemical is a terpene.

57. The formulation according to claim 56, wherein the terpene is D-limonene.

58. The formulation according to claim 51, wherein the one or more additives that are not antimicrobials is selected from the group consisting of flavoring agents, flavor enhancers, intensifiers, emulsifiers, binders, fillers, gelling agents, plasticizers, stabilizers, suspending agents, whipping agents, sweetening agents, flavoring agents, colors, enzymes, antioxidants, sequestrants, wetting agents, surfactants, curing and pickling agents, firming agents, fumigants, humectants, leavening agents, processing aids, surface active agents, surface finishing agents, synergists, texturizers, and combinations thereof.

59. An antimicrobial formulation comprising:
a) carbon dioxide;
b) a carrier chemical mixed with the carbon dioxide;
c) one or more antimicrobial ingredients soluble in the carrier chemical mixed with the mixture of the carrier chemical and the carbon dioxide; and
d) one or more additives that are not antimicrobials mixed with the mixture of the one or more antimicrobial ingredients soluble in the carrier chemical, the carrier chemical, and the carbon dioxide to form a substance with antimicrobial properties.

60. The formulation according to claim 59, wherein the carbon dioxide is in liquid form.

61. The formulation according to claim 59, wherein the carrier chemical is an alcohol.

62. The formulation according to claim 61, wherein the alcohol is ethanol.

63. The formulation according to claim 59, wherein the carrier chemical is propylene glycol.

64. The formulation according to claim 59, wherein the carrier chemical is a terpene.

65. The formulation according to claim 64, wherein the terpene is D-limonene.

66. The formulation according to claim 59, wherein the one or more antimicrobial ingredients soluble in the carrier chemical is selected from the group consisting of lauric argenate, potassium gluconate, ammonium lactate, potassium lactate, sodium lactate, sodium diacetate, methyl paraben and combinations thereof.

67. The formulation according to claim 59, wherein the one or more additives that are not antimicrobials is selected from the group consisting of flavoring agents, flavor enhancers, intensifiers, emulsifiers, binders, fillers, gelling agents, plasticizers, stabilizers, suspending agents, whipping agents, sweetening agents, flavoring agents, colors, enzymes, antioxidants, sequestrants, wetting agents, surfactants, curing and pickling agents, firming agents, fumigants, humectants, leavening agents, processing aids, surface active agents, surface finishing agents, synergists, texturizers, and combinations thereof.

68. An antimicrobial formulation comprising:
a) carbon dioxide;
b) water mixed with the carbon dioxide;
c) one or more antimicrobial ingredients soluble in water mixed with the mixture of the water and the carbon dioxide; and
d) one or more additives that are not antimicrobials mixed with the mixture of the one or more antimicrobial ingredients soluble in water, the water, and the carbon dioxide to form a substance with antimicrobial properties.

69. The formulation according to claim 68, wherein the carbon dioxide is in liquid form.

70. The formulation according to claim 68, wherein the one or more antimicrobial ingredients soluble in water is selected from the group consisting of potassium nitrite, potassium nitrate, and combinations thereof.

71. The formulation according to claim 68, wherein the one or more additives that are not antimicrobials is selected from the group consisting of flavoring agents, flavor enhancers, intensifiers, emulsifiers, binders, fillers, gelling agents, plasticizers, stabilizers, suspending agents, whipping agents, sweetening agents, flavoring agents, colors, enzymes, antioxidants, sequestrants, wetting agents, surfactants, curing and pickling agents, firming agents, fumigants, humectants, leavening agents, processing aids, surface active agents, surface finishing agents, synergists, texturizers, and combinations thereof.

72. An antimicrobial formulation comprising:
a) carbon dioxide;
b) water mixed with the carbon dioxide;
c) a carrier chemical mixed with the mixture of the water and the carbon dioxide;
d) one or more antimicrobial ingredients soluble in water mixed with the mixture of the carrier chemical, the water, and the carbon dioxide;
e) one or more antimicrobial ingredients soluble in the carrier chemical mixed with the mixture of the one or more antimicrobial ingredients soluble in water, the carrier chemical, the water, and the carbon dioxide; and
f) one or more additives that are not antimicrobials mixed with the mixture of the one or more antimicrobial ingredients soluble in the carrier chemical, the one or more antimicrobial ingredients soluble in water, the carrier chemical, the water, and the carbon dioxide to form a substance with antimicrobial properties.

73. The formulation according to claim 72, wherein the carrier chemical is an alcohol.

74. The formulation according to claim 73, wherein the alcohol is ethanol.

75. The formulation according to claim 72, wherein the carrier chemical is propylene glycol.

76. The formulation according to claim 72, wherein the carrier chemical is a terpene.

77. The formulation according to claim 76, wherein the terpene is D-limonene.

78. The formulation according to claim 72, wherein the one or more antimicrobial ingredients soluble in water is selected from the group consisting of potassium nitrite, potassium nitrate, and combinations thereof.

79. The formulation according to claim 72, wherein the one or more antimicrobial ingredients soluble in the carrier chemical is selected from the group consisting of lauric argenate, potassium gluconate, ammonium lactate, potassium lactate, sodium lactate, sodium diacetate, methyl paraben and combinations thereof.

80. The formulation according to claim 72, wherein the one or more additives that are not antimicrobials is selected from the group consisting of flavoring agents, flavor enhancers, intensifiers, emulsifiers, binders, fillers, gelling agents, plasticizers, stabilizers, suspending agents, whipping agents, sweetening agents, flavoring agents, colors, enzymes, antioxidants, sequestrants, wetting agents, surfactants, curing and pickling agents, firming agents, fumigants, humectants, leavening agents, processing aids, surface active agents, surface finishing agents, synergists, texturizers, and combinations thereof.
